(19) United States
(12) Patent Application Publication
(10) Pub. No.: US 2026/0254266 A1
(43) Pub. Date: Aug. 27, 2026

(54) ELECTRONIC DOOR LOCK SYSTEM AND METHOD FOR CHARGING THE SAME

(71) Applicant: INN CONTROL, LLC, VALLEY VILLAGE, CA (US)

(72) Inventors: JACK HOWARD, VALLEY VILLAGE, CA (US); KEVIN HUNG, SANTA ANA, CA (US); RAY TANDOG, GLENDALE, CA (US)

(73) Assignee: INN CONTROL, LLC, VALLEY VILLAGE, CA (US)

(21) Appl. No.: 19/549,784

(22) Filed: Feb. 25, 2026

Related U.S. Application Data
(60) Provisional application No. 63/763,016, filed on Feb. 25, 2025.

(51) Int. Cl. H02J 7/70; E05B 47/00; H02J 50/10

(52) U.S. Cl. CPC H02J 7/70; E05B 47/0001; H02J 50/10; E05B 2047/0058; E05B 2047/0061; E05B 2047/0082

(57) ABSTRACT

Described is an electronic door lock system. The system includes an electrically powered door lock assembly for mounting to a door. A rechargeable battery is electrically connected to the door lock assembly. Further, a frame mounted power transfer assembly is included for connecting to a building electrical system, while a door mounted power transfer assembly is connected to the rechargeable battery. The door mounted power transfer assembly is positioned to engage the frame mounted power transfer assembly when the door is in a closed position. Upon engagement of the door mounted power transfer assembly to the frame mounted power transfer assembly, electrical current flows from the building electrical system to the rechargeable battery to charge the rechargeable battery.

### CROSS-REFERENCE TO RELATED APPLICATIONS

The present application is a non-provisional application of U.S. Ser. No. 63/763,016, filed on Feb. 25, 2025, the entirety of which is incorporated herein by reference.

### BACKGROUND OF THE INVENTION

### (1) Field of Invention

The present invention relates to electronic door locks and, more particularly to an electronic door lock system having a rechargeable battery that is charged through a building's existing electrical architecture.

### (2) Description of Related Art

Motorized door locks have long been known in the art. While operable for locking/unlocking the door, they all require batteries that need monitoring and manual replacement. Traditional smart locks rely on replaceable batteries or external power sources, leading to frequent battery changes and potential failures. A direct charging system would eliminate these issues by integrating power transfer into the lock mechanism through a buildings existing electrical architecture.

Thus, a continuing need exists for a new and improved electronic door lock that eliminates the need for manual battery replacement.

### SUMMARY OF INVENTION

The system includes an electrically powered door lock assembly for mounting to a door. A rechargeable battery is electrically connected to the door lock assembly. Further, a frame mounted power transfer assembly is included for connecting to a building electrical system, while a door mounted power transfer assembly is connected to the rechargeable battery. The door mounted power transfer assembly is positioned to engage the frame mounted power transfer assembly when the door is in a closed position. Upon engagement of the door mounted power transfer assembly to the frame mounted power transfer assembly, electrical current flows from the building electrical system to the rechargeable battery to charge the rechargeable battery.

In another aspect, a power converter is included for connecting between the frame mounted power transfer assembly and the building electrical system.

In yet another aspect, the frame mounted power transfer assembly and the door mounted power transfer assembly are formed to wirelessly transfer power therebetween through inductive charging.

In another aspect, the electrically powered door lock assembly includes an electric control panel for operating the door lock assembly.

In yet another aspect, the power converter is incorporated into a wall outlet assembly that has a plug outlet while also having a battery charger electrical line for connecting to the frame mounted power transfer assembly.

In another aspect, the power converter is incorporated into a light switch assembly that is operable for turning on/off a light while also having a battery charger electrical line for connecting to the frame mounted power transfer assembly.

In yet another aspect, the invention includes a method for charging an electronic door lock system. The method includes several acts, including mounting an electrically powered door lock assembly to a door, the electrically powered door lock assembly having a rechargeable battery connected thereto; mounting a frame mounted power transfer assembly to a door frame; connecting the frame mounted power transfer assembly to a building electrical system; mounting a door mounted power transfer assembly to a door; connecting the door mounted power transfer assembly to the rechargeable battery; and causing the door mounted power transfer assembly to engage the frame mounted power transfer assembly when the door is in a closed position, such that upon engagement, electrical current to flows from the building electrical system to the rechargeable battery to charge the rechargeable battery.

Finally, as can be appreciated by one in the art, the present invention also comprises a method for forming and using the invention as described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a flow chart depicting the electrical power flow from a building's electrical system to a lock system according to various embodiments of the present invention;

FIG. 2 is an illustration depicting a door frame and associated door lock system according to various embodiments of the present invention;

FIG. 3 is an illustration of a light switch according to various embodiments of the present invention; and

FIG. 4 is an exploded-view illustration of a door lock mechanism according to various embodiments of the present invention.

### DETAILED DESCRIPTION

The present invention relates to electronic door locks and, more particularly, to an electronic door lock system having a rechargeable battery that is charged through a building's existing electrical architecture. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

### (1) Description

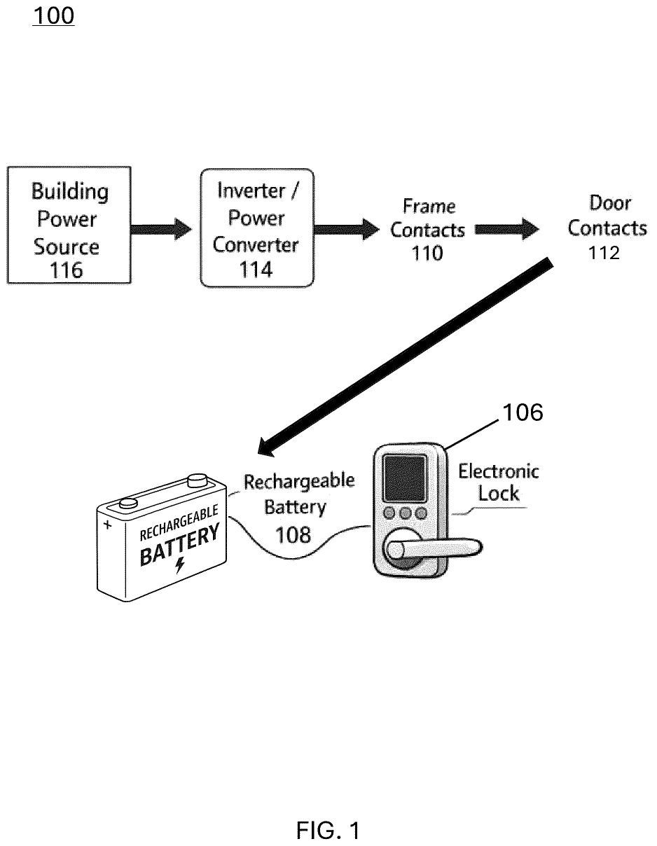

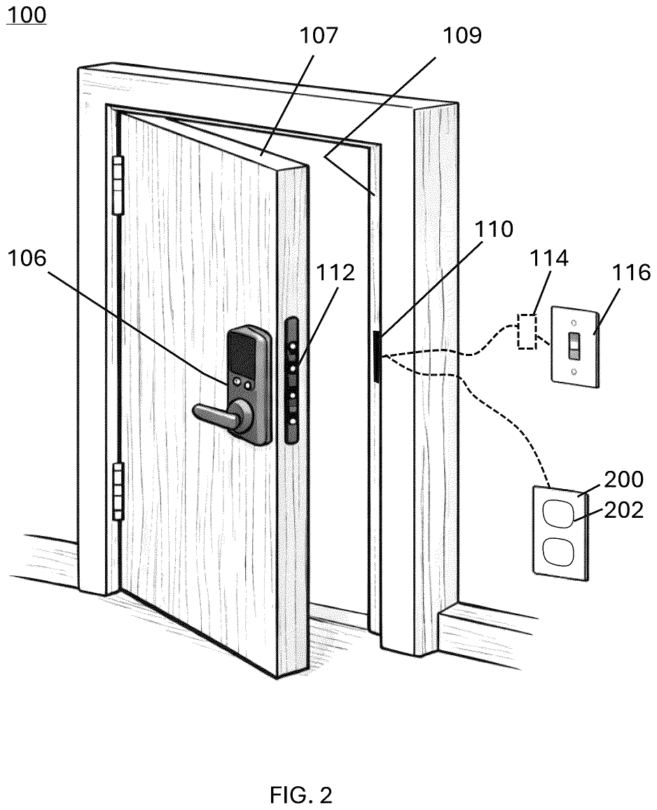

As shown in FIGS. 1 and 2, the present invention relates to an electronic door lock system 100 having a rechargeable battery 108 that is charged through a building's existing architecture (i.e., using the building's power source 116). This invention allows for charging an electronic door lock assembly 106 by passing electrical power to the door lock assembly 106 when a door 107 is closed and engaged with the door frame 109. In some instances a power converter 114 is necessary to alter the voltage and/or current to the desired range when passing the electricity to the frame contacts 110, which in turn pass the electricity to door contacts 112 and finally to the rechargeable battery 108.

Thus, when installed, the door lock system 100 includes a door 107 movably mounted to a door frame 109; an electrically powered lock assembly 106 mounted to the door 107; a rechargeable battery 108 housed within the lock assembly 106 or within the door 107; a frame-mounted contact (e.g., electrical or wireless, etc.) assembly 110; a door-mounted contact (electric or wireless, etc.) assembly 112; and a power converter 114 electrically connected to a building electrical source, or any combination thereof to facilitate the charging of the electronic lock as described herein.

The design eliminates the need for battery replacement and ensures continuous power supply from the building's power source 116. The system 100 can be used with any suitable electronic and/or motorized lock mechanism that is designed with the components described/depicted herein to receive power from the buildings electrical system 116 to charge the battery 108. As a non-limiting example, any electronic door lock mechanism known to those skilled in the art (e.g., those provided by Schlage®, etc.) can be modified to include the components described herein to operate as a lock system where the battery is charged through the buildings electrical system as depicted and described. In a commercial or hotel setting, although the door lock mechanism may not have a motorized deadbolt, the door lock mechanism is still electronic and requires a battery to power the card reader and/or unlock the door. Thus, the system as described herein can be employed in residential, commercial, or any other setting in which a door lock mechanism requires a battery.

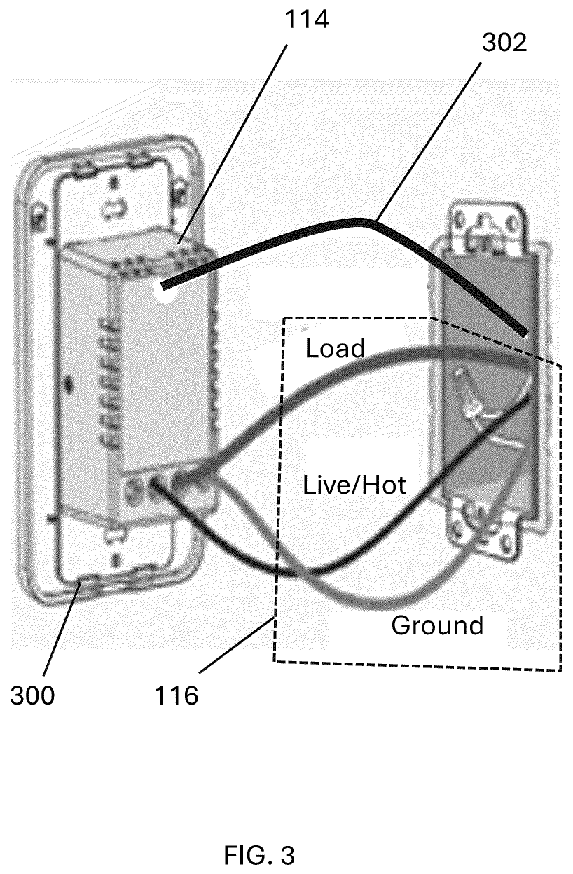

As noted above, the electronic lock system derives electrical power from an existing building electrical circuit. In various embodiments, the power source 116 may be a nearby light switch circuit (as illustrated in FIGS. 2 and 3), a wall outlet, a junction box, a dedicated branch circuit, etc. To safely pass electricity to the rechargeable battery, the electrical power is routed through a power converter 114 on its way to the contacts 110 and 112 and electronic door lock assembly 106. The power converter 114 may include one or more of a step-down transformer, an AC-to-DC rectifier, a DC regulator, an inverter, a voltage limiter, overcurrent protection circuitry, or any other suitable circuitry or device operable for converting the building's electrical power to the desired parameter.

The power converter 114 outputs a regulated charging voltage appropriate for the rechargeable battery 108, which may be lithium-ion, lithium polymer, nickel-metal hydride, or other rechargeable chemistry. Safety features can be built into the power converter 114, such as ground fault protection, current limiting, short-circuit protection, thermal protection, and isolation circuitry.

In installation, the power converter 114 can be wired inline between the electrical power 116 and frame mounted power transfer assembly 110 or built into any of the components. As a non-limiting example and as shown in FIG. 3, the building's electrical power 116 can be wired into a specially designed light switch assembly 300 that has the power converter 114 built into the light switch assembly 300. In this aspect, a battery charger electrical line 302 is fed out from the power converter 114 in the light switch assembly 300 to the frame mounted power transfer assembly 110. Thus, in this aspect, the light switch assembly 300 is operable for turning on/off a light while also having a battery charger electrical line 302 for connecting to the frame mounted power transfer assembly 110. As can be appreciated by those skilled in the art, the power converter can similarly be implemented or otherwise integrated into a custom wall outlet assembly 200 that, in addition to providing a wall plug outlet 202, has a battery charger electrical line that is fed out from the power converter (in the wall outlet assembly 200) to the frame mounted power transfer assembly 110.

The frame-mounted power transfer assembly 110 is installed within or adjacent to the strike plate area of the door frame 109, or anywhere in the door frame 109 such that it aligns with the associated door mounted power transfer assembly 112. The frame mounted power transfer assembly 110 is any suitable mechanism, device, and/or configuration that ultimately allows for power to flow to the rechargeable battery 108.

The door-mounted power transfer assembly 112 is positioned along the outer edge of the door 102 or at any suitable location such that when the door is closed, the door mounted power transfer assembly 112 aligns with the frame mounted power transfer assembly 110 (and presses against in the direct contact configuration). The door mounted power transfer assembly 112 is any suitable mechanism, device, and/or configuration that ultimately allows for power to flow to the rechargeable battery 108. In some embodiments, the door mounted power transfer assembly 112 includes electrical contacts that are configured for direct contact and electrical transfer, non-limiting examples of which include electrical contacts that are spring-loaded, conductive pads or plates, self-aligning, and/or configured with polarity protection. While desirably affixed at the edge of the door 107, the direct electrical contacts can be formed in the bolt as disclosed in U.S. Provisional Application No. 63/763,016. As another example and as described in further detail below, the door mounted power transfer assembly 112 can be formed to wirelessly receive power from the frame mounted power transfer assembly 110 (e.g., through inductive charging, etc.). In either configuration, wiring embedded within the door 107 (or other components as necessary) connects the door-mounted contacts to the rechargeable battery 108 and optionally to a charging control circuit.

In one aspect and as noted above, the frame mounted power transfer assembly 110 is configured to provide an electrical connection through direct contact with the associated door mounted power transfer assembly 112 using any contacts or any components as may be required, such as two or more conductive pins, spring-biased pogo pins, conductive plates, and recessed contact terminals. This method provides efficient charging without the energy loss associated with inductive charging. However, to maintain long-term reliability, the contacts must be designed with self-cleaning/protecting properties, such as spring-loaded or sliding contact surfaces, and be plated with corrosion-resistant materials like gold or nickel. In one aspect, the contacts may be partially recessed to reduce exposure and prevent accidental contact.

When the door is in an open position, the contacts of the frame and door contact assemblies 110 and 112 are separated, and no electrical current flows. Alternatively, when the door is moved to the closed position:
a. The door-mounted contacts physically engage the frame-mounted contacts.
b. An electrical circuit is completed.
c. Current flows from the building electrical system through the power conversion circuit.
d. Regulated charging voltage passes through the frame contacts.
e. Electrical current flows into the door contacts.
f. The battery charging circuit regulates current to recharge the rechargeable battery. Charging may occur continuously while the door remains closed or intermittently according to battery management logic.

In another aspect and as noted above, the frame mounted power transfer assembly 110 is configured to provide wireless charging to an associated wireless door mounted power transfer assembly 112. In this aspect, both of the contact assemblies 110 and 112 are configured to facilitate such wireless charging using any suitable technology as understood by those skilled in the art. As a non-limiting example, the contact assemblies 110 and 112 can be configured to provide for inductive charging. Inductive charging eliminates the need for physical electrical contact between the contact assemblies 110 and 112, reducing mechanical wear and improving reliability. For example and in one aspect, the frame mounted power transfer assembly 110 contains an inductive coil, which is connected into the building's electrical system as described above. The door mounted power transfer assembly 112 includes a corresponding receiving coil that picks up power wirelessly when engaged. The power is then converted into DC voltage to charge the battery 108, which in turn powers the door lock assembly 106. This method ensures continuous power delivery when the door is closed, eliminates issues related to corrosion and misalignment, and allows for a fully enclosed, weather-resistant design.

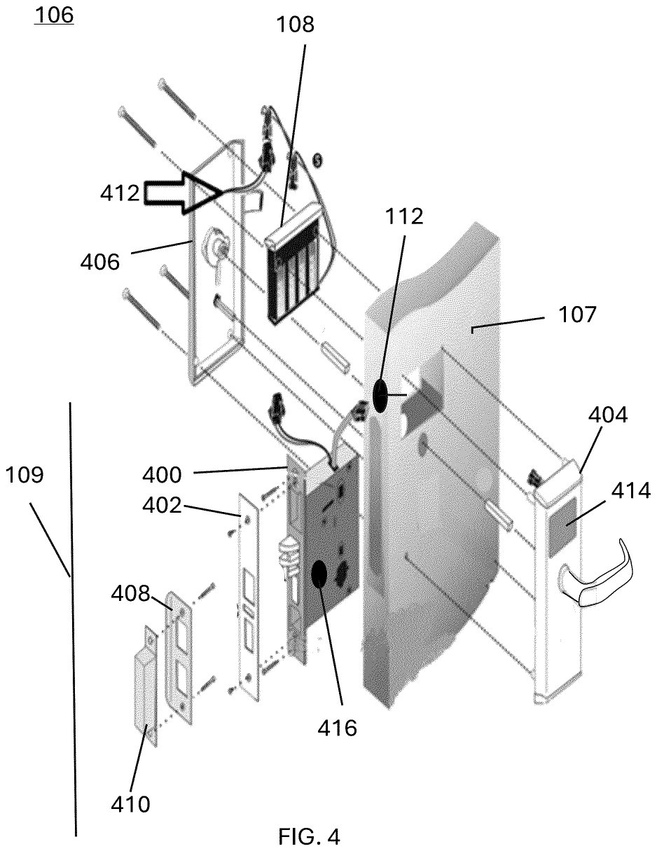

The door lock assembly 106 is any electronic door lock mechanism that allows for a motorized lock and/or electronic control or features. For example, some smart door locks include digital or electric control panels 414, wireless features, and/or motorized lock bolts (e.g., via a motor 416), all of which require electric power. Thus, the door lock assembly 106 is any door lock mechanism that can benefit from a rechargeable battery 108, a non-limiting example of which is illustrated in FIG. 4. FIG. 4 is an exploded-view illustration, depicting a door lock assembly 106 being affixed with a door 107. In this example, a mortise 400 and side cover plate 402 are installed in the door 107. The mortise 400 in this example includes a mechanical lock for locking the door 107 to the frame 109 via a strike plate 408 and frame box 410. Front 404 and back 406 panels are affixed to the door frame 107 to control the mortise 400 and locks therein while also connecting with the rechargeable battery 108 for electrical control.

As noted above, the door mounted power transfer assembly 112 can include direct electrical contacts or any other suitable component, such as a receiving coil that picks up power wirelessly when engaged. For example, the door mounted power transfer assembly 112 (e.g., receiving coil or, in another aspect, direct electrical contacts) can be mounted at the edge of the door 107 for a wired connection 412 to the battery 108 or any other component as necessary to facilitate power to and charging of the battery 108. As another example, the door mounted power transfer assembly 112 can be integrally formed into the mortise 400 to provide a streamlined product and installation process.

As can be appreciated by those skilled in the art, there are several variations that can be applied to the present invention. Several non-limiting examples of variations include:
a. Multi-Function Door Lock Assembly:
   i. In addition to power transfer, the door lock assembly 106 can also be designed as a smart lock to transmit data, allowing the lock system to communicate with operators and/or the building's security infrastructure. This could enable real-time lock status updates, biometric verification data transmission, or even emergency override capabilities. The data could be transferred through dedicated electrical contacts, inductive coupling, or even optical transmission through embedded fiber optics. By integrating both power and data transmission, this variation allows for seamless integration with smart home and security systems, enabling features like remote monitoring, logging access history, and integrating with access control systems.
b. Battery Management System Safeties:
   i. The door lock assembly 106 can be configured to implement safeties into the battery management system to prevent shocks to users. If the current exceeds a threshold the charging circuit will shut off.
c. Smart Lock with Self-Lock and Power Harvesting:
   i. This variation incorporates energy-harvesting technology to reduce dependency on external power sources. The system could generate power through:
      1. Kinetic Energy Harvesting—A small generator inside the lock converts mechanical motion (from opening, closing, or user interaction) into electrical energy.
      2. Piezoelectric Energy—Small piezoelectric elements in the bolt generate a small charge from mechanical stress when the bolt engages or disengages.
      3. Solar Integration—A compact solar cell on an outdoor-facing panel supplements battery charging.
   ii. By incorporating self-locking mechanisms, the system could automatically engage based on predefined conditions (e.g., motion sensors, door alignment). These energy-efficient innovations extend battery life significantly, ensuring lock functionality even in power outages or off-grid environments.
d. Modular Bolt System for Retrofitting Existing Locks:
   i. A modular approach allows the charging bolt system to be retrofitted into existing deadbolts, electronic locks, and mechanical lock systems. Instead of requiring a full lock replacement, this system adapts to existing lock housings, making it cost-effective and easy to install. This modular design could support various power transfer methods, including direct contact, inductive charging, or hybrid solutions, depending on the existing lock configuration. Additionally, the modular nature enables customization for different lock brands, security levels, and smart integration needs.
e. Electromagnetic Bolt Locking:
   i. Instead of a mechanical bolt, an electromagnetic system could be used, where the lock engages and disengages based on an electromagnetic field rather than physically extending a bolt. Power transfer through wireless induction or conductive plates could keep the magnetic lock energized. This system reduces wear, allows for faster locking/unlocking, and can be designed for fail-safe or fail-secure configurations (i.e., locked when power is off or vice versa).

It should be understood that the lock system includes any components as necessary to implement the electronic door lock system as described. Further, while some specific examples are provided, the invention is not intended to be limited thereto as other variations (e.g., voltages, current, etc.) can be implemented as desired and applicable to the specific installation. Finally, while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while particular method steps have been recited in a particular order, the method steps may occur in any desired order and fall within the scope of the present invention.

What is claimed is:

1. An electronic door lock system comprising:
an electrically powered door lock assembly for mounting to a door;
a rechargeable battery electrically connected to the door lock assembly;
a frame mounted power transfer assembly for connecting to a building electrical system;
a door mounted power transfer assembly electrically connected to the rechargeable battery;
wherein the door mounted power transfer assembly is positioned to engage the frame mounted power transfer assembly when the door is in a closed position; and
wherein engagement of the door mounted power transfer assembly to the frame mounted power transfer assembly permits electrical current to flow from the building electrical system to the rechargeable battery to charge the rechargeable battery.

2. The system of claim 1, further comprising a power converter for connecting between the frame mounted power transfer assembly and the building electrical system.

3. The system of claim 2, wherein the frame mounted power transfer assembly and the door mounted power transfer assembly are formed to wirelessly transfer power therebetween through inductive charging.

4. The system of claim 3, wherein the electrically powered door lock assembly includes an electric control panel for operating the door lock assembly.

5. The system of claim 4, wherein the power converter is incorporated into a wall outlet assembly that has a plug outlet while also having a battery charger electrical line for connecting to the frame mounted power transfer assembly.

6. The system of claim 4, wherein the power converter is incorporated into a light switch assembly that is operable for turning on/off a light while also having a battery charger electrical line for connecting to the frame mounted power transfer assembly.

7. The system of claim 2, wherein the power converter is incorporated into a wall outlet assembly that has a plug outlet while also having a battery charger electrical line for connecting to the frame mounted power transfer assembly.

8. The system of claim 2, wherein the power converter is incorporated into a light switch assembly that is operable for turning on/off a light while also having a battery charger electrical line for connecting to the frame mounted power transfer assembly.

9. The system of claim 1, wherein the frame mounted power transfer assembly and the door mounted power transfer assembly are formed to wirelessly transfer power therebetween through inductive charging.

10. The system of claim 1, wherein the electrically powered door lock assembly includes an electric control panel for operating the door lock assembly.

11. A method for charging an electronic door lock system, comprising acts of:
mounting an electrically powered door lock assembly to a door, the electrically powered door lock assembly having a rechargeable battery connected thereto;
mounting a frame mounted power transfer assembly to a door frame;
connecting the frame mounted power transfer assembly to a building electrical system;
mounting a door mounted power transfer assembly to a door;
connecting the door mounted power transfer assembly to the rechargeable battery; and
causing the door mounted power transfer assembly to engage the frame mounted power transfer assembly when the door is in a closed position, such that upon engagement, electrical current to flows from the building electrical system to the rechargeable battery to charge the rechargeable battery.
